(19) United States
(12) Patent Application Publication
(10) Pub. No.: US 2014/0067514 A1
(43) Pub. Date: Mar. 6, 2014

(54) MERCHANT ACQUISITION AND ADVERTISEMENT BUNDLING WITH OFFERS AND LEAD GENERATION SYSTEM AND METHOD

(71) Applicants: Antonio Vitti, Oakland, CA (US); John Vitti, San Mateo, CA (US); Howard Lewis, San Jose, CA (US)

(72) Inventors: Antonio Vitti, Oakland, CA (US); John Vitti, San Mateo, CA (US); Howard Lewis, San Jose, CA (US)

(73) Assignee: Mobile Spinach, Inc., San Mateo, CA (US)

(21) Appl. No.: 13/603,143

(22) Filed: Sep. 4, 2012

(51) Int. Cl. G06Q 30/00

(52) U.S. Cl. CPC G06Q 30/0236
USPC 705/14.36; 705/14.1

(57) ABSTRACT

A system and method for merchant conversions are described using a facsimile or email or phone. The system may utilize machine learning to implement the merchant conversion.

### APPENDIX

Appendix A (1 page) is an example of the merchant data used by the merchant conversion system and method; and

Appendix B (2 pages) contain an example of the machine learning process of the merchant conversion system and method.

Both appendices forms part of the specification.

### FIELD

The disclosure relates generally to merchant conversion and in particular to a system and method that improves merchant conversion.

### BACKGROUND

A system that exists modernly is a local merchant offer system in which a deal is offered to a user. Now, Local Merchant Offer websites have popped up by the hundreds with the introduction of the Groupon business model. However, just as fast as they popped up, many of the Local Merchant Offer businesses have closed their doors lately because of the lack of profitability. The local merchant offer business model is fairly easy to emulate except for one thing that has always been a problem: economically and profitably acquiring merchant offers. Merchant “offers” are typically defined as discounted prices or bundled offers given to consumers for the merchant's goods or services. The merchant offers can also be either one day deals or “evergreen” deals that run for more than one day or are repeatedly offered in the future. The merchant offers can also be defined as general advertising campaigns (radio, television, print media, display ad, digital media, banners ads, impression based, click to call, pay per click, pay per action, etc.,) separately purchased by the merchant and/or bundled with the aforementioned discounted goods or services offers. The merchant offers also can be a combination of all the aforementioned.

The acquisition of merchant offers has always been an expensive, manual sales force intensive process and typically accounts for the bulk of operational expenditure of local merchant offer businesses, in many cases exceeding 50% of their operational expenditure. This sales process, like all human sales processes, has seen very little automation and historically has been thought as impossible to automate. The only technology driven automation of this process to date has centered on the information tools used by salespeople. Typical examples of these sales tools are CRM (customer relationship management) tools such as Salesforce.com, which are essentially advanced digital rolodexes.

Daily deal businesses must increasingly spend a great deal of their financial resources to grow their sales team headcount to acquire a greater number of merchant offers. In the local merchant offer industry (and other sales-driven industries), there is a direct linear relationship between the physical number of salespeople and the number of merchant offers that a sales force can acquire. Additionally, sales forces typically experience a high degree of personnel churn which is very expensive both financially and operationally. With these aforementioned problems inherent in current merchant acquisition processes, the cost of acquiring merchant offers is very high; for some of the larger local merchant offer companies it can typically cost over $7000 per merchant offer acquisition. Additionally, conversion rates using the traditional method of acquisition have been historically as low as 1-2% per salesperson.

Thus, it is desirable to automate the above merchant acquisition to reduce the cost of acquiring each merchant offer and improve the merchant conversion rates and it is to this end that the disclosure is directed.

### BRIEF DESCRIPTION OF THE DRAWINGS

FIG. 1A illustrates an implementation of a mobile voucher system that may incorporate a merchant conversion system;

FIG. 1B illustrates an implementation of a merchant conversion system;

FIGS. 2A-2D are a flowchart of a method for merchant conversion;

FIGS. 3A-3D illustrates an example of a merchant conversion flyer;

FIGS. 4A-4D illustrates another example of a merchant conversion flyer;

FIGS. 5A-5D illustrates yet another example of a merchant conversion flyer; and

FIGS. 6A-6C illustrates an example of a merchant advance conversion flyer.

### DETAILED DESCRIPTION OF ONE OR MORE EMBODIMENTS

The disclosure is particularly applicable to a merchant conversion system used in a mobile voucher system in which one or more smartphones (Apple iPhone, Android OS based phones, etc.) are used to interact with a mobile voucher system in a client/server type architecture over the Internet and it is in this context that the disclosure will be described. It will be appreciated, however, that the system and method has greater utility since it can be implemented using other mobile devices, may be implemented using other computer architectures and may be used for other mobile type applications that are within the scope of this disclosure. Furthermore, the system and method may be used to automate the salesperson's capabilities and the sales process for any sales driven effort in any industry. For example, the system may be used in a business to customer (B-to-C) sales industry, such as insurance policies, home maintenance solutions, etc.), a business to business (B-to-B) sales industry, such as advertising, industrial supplies, etc. and the system can also be used to sell general advertising campaigns to the merchants.

The system and method automates or virtualizes the salesperson's capabilities and the sales process itself using a combination of software and hardware solutions. The system and method automatically cuts or eliminates sales force head count, decrease costs, increase profit margins, increase sales cycle speed efficiency, create more profit, and improve merchant conversion rates by a factor of 4-5 times or more than traditional sales force alternatives.

The merchant offer acquisition system and method automates the entire process by first scanning multiple sources for merchant information and populating the merchant information database with the correct merchant information as well as the correct contact information and contact method. Then, using the obtained information, the system may generate optimized merchant offer terms and a sales pitch or informational memorandum as well as calculate the optimal time to contact the merchant with the deal offer package (which contains the sales pitch, proposed merchant offer details, contract, and incentive bonus or advance payment). In addition, the more merchant offers that the system pursues/processes, the better the system learns from its failures and successes. The system brings the marginal economic cost of merchant offer acquisition down to near $0 and improves the merchant offer acquisition rate from 2% to 5-15%. Now, an example of a mobile voucher system that may incorporate a merchant offer acquisition system is described.

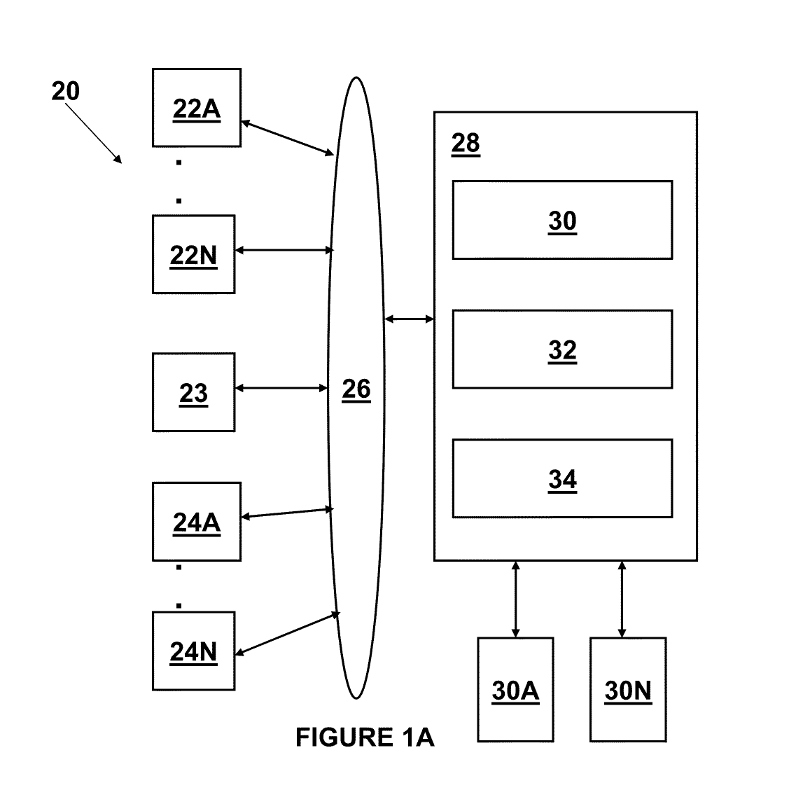

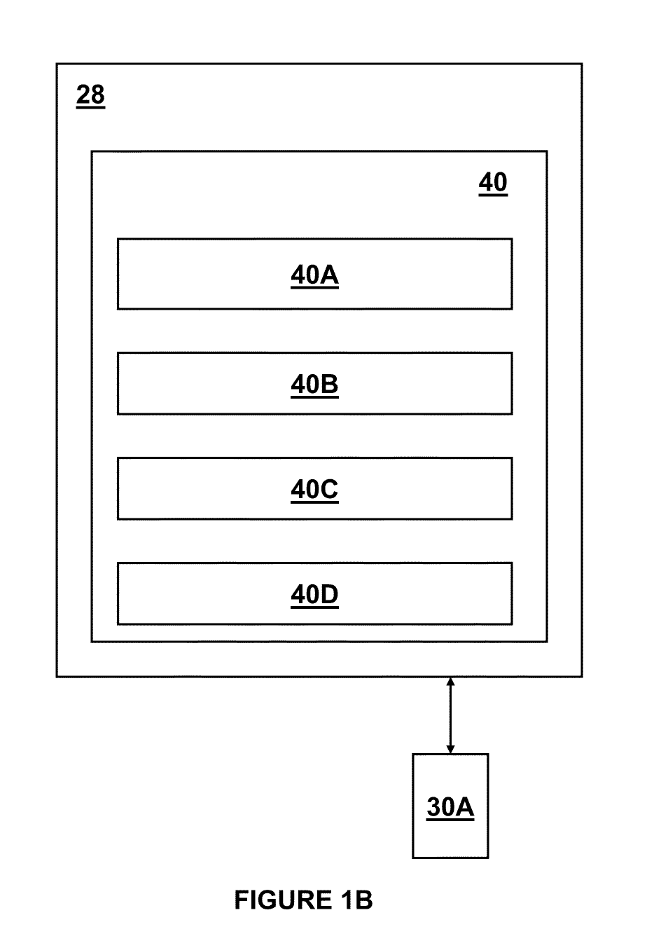

FIG. 1A illustrates an implementation of a mobile voucher system 20. The mobile voucher system 20 may have one or more consumer computing devices 22A-22N, one or more publisher systems 23 and one or more merchant systems 24A-24N that communicate with and interact over a link 26 to a mobile voucher unit 28. The system may have one or more stores 30, such as store 30A, . . . , store 30N, that store the various data that is used by the system including consumer data, merchant data, merchant offer data and the like. The one or more consumer computing devices 22A-22N may each be a processing unit based device with sufficient processing power, memory capacity and wired/wireless connectivity to communicate with and interact over the link 26 to the mobile voucher unit 28 as described below in more detail. For example, each consumer computing device may be a smartphone mobile device (such as an Apple® iPhone®, a RIM® Blackberry® device, Windows Phone 7, an Android operating system-based device and the like), a laptop computer, desktop personal computer (PC), a tablet computer (such as the Apple® iPad® and the like) and other devices that are capable of communicating with and interacting over the link 26 to the mobile voucher unit 28. The one or more publisher systems 23 may each be a processing unit based device with sufficient processing power, memory capacity and wired/wireless connectivity to communicate with and interact over the link 26 to the mobile voucher unit 28 as described below in more detail. For example, each publisher system may be one or more server computers, a personal computer, a laptop computer, a tablet computer, a smartphone and the like. The one or more merchant systems 24A-24N may each be a processing unit based device with sufficient processing power, memory capacity and wired/wireless connectivity to communicate with and interact over the link 26 to the mobile voucher unit 28 as described below in more detail. For example, each merchant system may be one or more server computers, a personal computer, a laptop computer, a tablet computer, a smartphone and the like. Each merchant system also may be just a facsimile machine that allows the merchant to interact with the mobile voucher unit 28. The link 26 may be a wireless or wired link that may be a computer network, a cellular network, a cellular digital data network, an internet-based network, a communications network and the like. The mobile voucher unit 28 may be one or more server computers that execute the code to implement the functions and operations of the mobile voucher unit 28, one or more cloud based resources that execute the code to implement the functions and operations of the mobile voucher unit 28 or one or more hardware devices that implement the functions and operations of the mobile voucher unit 28. In one embodiment, each consumer computing device is a smartphone device, each publisher system and each merchant system is one or more server computers, the link is the Internet and the mobile voucher unit 28 is one or more server computers. Although the system in FIG. 1 has a client/server type architecture, the system also may be implemented using a SaaS architecture, a cloud based architecture and the like since the system is not limited to any particular system architecture, type of consumer computing device, type of publisher or merchant system or link.

In one implementation, each consumer computing device may have a browser application that is capable of communicating and interacting with the mobile voucher unit 28. In other implementations, each consumer computing device may have an app (a stand alone app or an app that operates inside of another app) that is capable of communicating and interacting with the mobile voucher unit 28. The publisher system(s) and merchant system (s) may similarly have browser applications or apps that is capable of communicating and interacting with the mobile voucher unit 28.

In operation, each consumer computing device, using the browser or app, may indicate an interest in a syndicated deal/voucher, purchase a voucher from the mobile voucher unit 28 and then redeem the voucher at a merchant who is a member of the mobile voucher unit 28. Each publisher system is a system that a person/business user, who wishes to generate an app (game application, commerce application, etc.) that embeds the mobile voucher app, to submit their app into which the mobile voucher app from the mobile voucher unit 28 may be integrated. Each merchant system allows the merchant to interact with the mobile voucher unit 28 and participate in the mobile vouchers that are generated by the mobile voucher unit 28.

FIG. 1B illustrates an implementation of a merchant conversion system 40 that is implemented within the mobile voucher unit 28. In one implementation, each portion/unit of the merchant conversion system 40 described below may be a plurality of lines of computer code that may be executed by the one or more processors of a computer, such as a computer that hosts and executes the mobile voucher unit 28. The merchant conversion system 40 may interface with the store 30A that stores the data for the various merchant conversion processes, stores the merchant data and the like. The merchant conversion system 40 may further comprise a merchant conversion unit 40A that manages the overall merchant conversion process, a machine learning unit 40B that performs machine learning as part of the merchant conversion process, an incentive and merchant package generator 40C that generates the incentive and package for each merchant that is part of the merchant conversion process and a merchant tracking unit 40D that tracks when each merchant accepts the merchant offer that is part of the merchant conversion process described below in more detail. In one implementation, the incentive payment is a virtual credit card as described below in more detail.

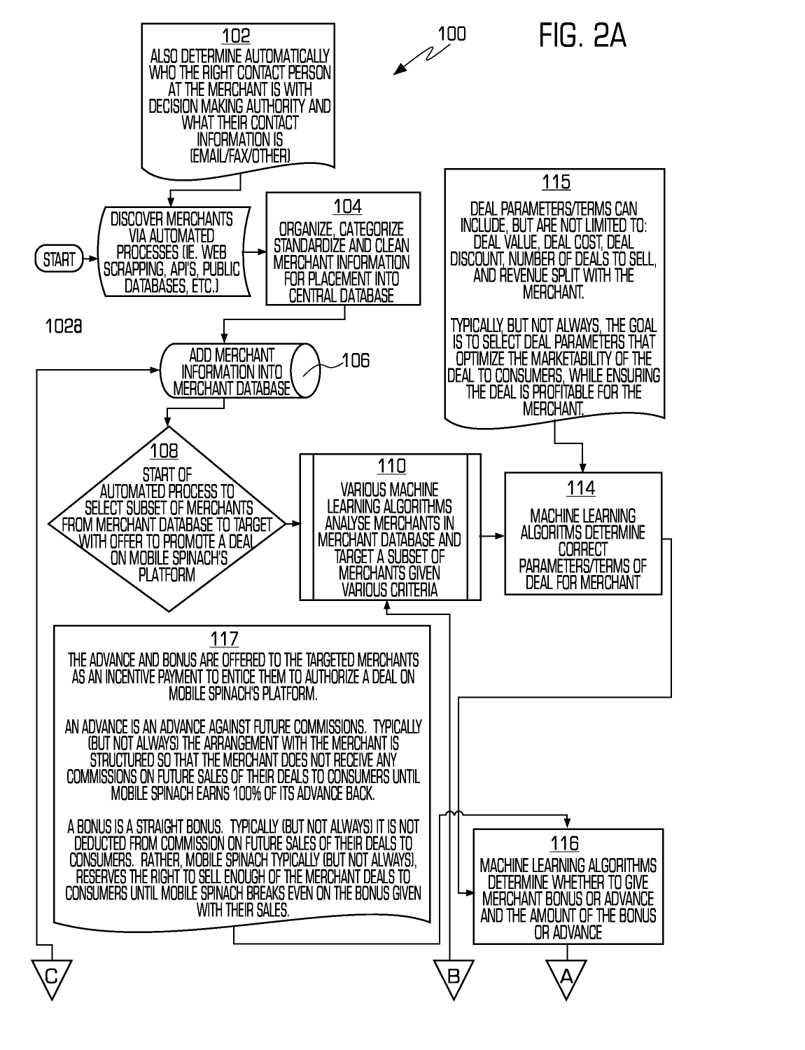

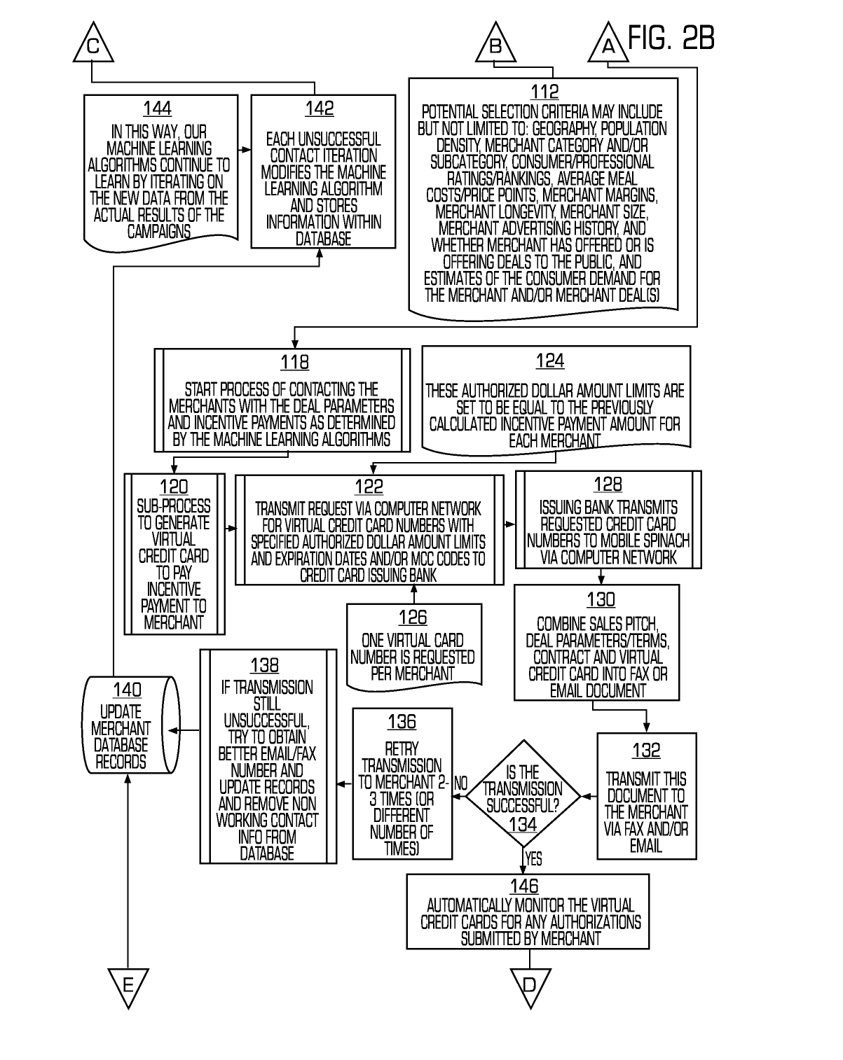

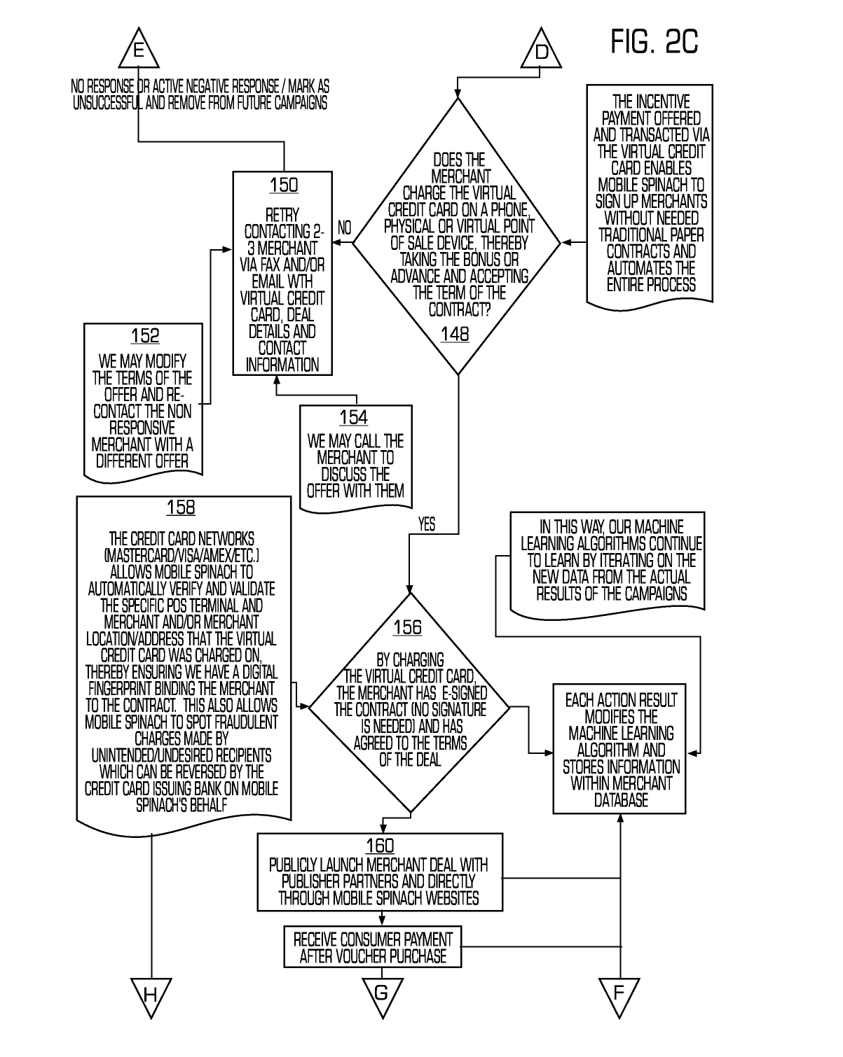

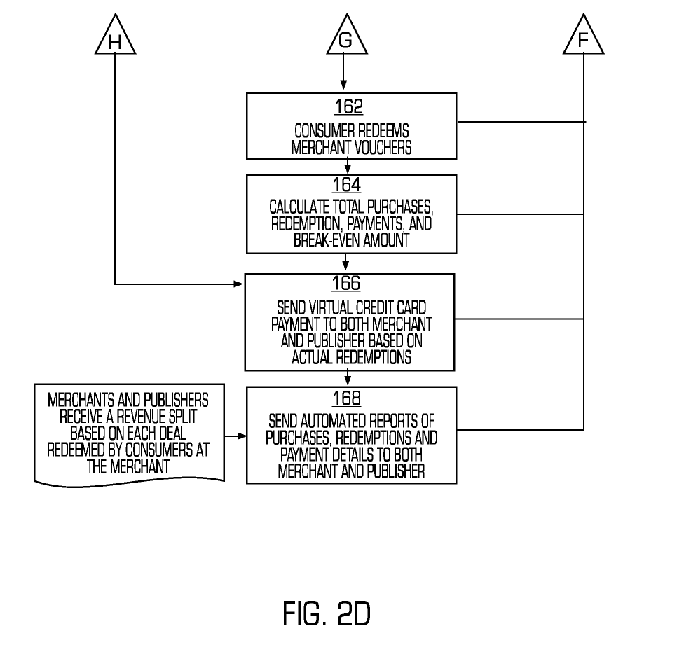

FIGS. 2A-2D are a flowchart of a method 100 for merchant conversion with machine learning. The method is carried out, in one embodiment, by the merchant conversion system 40 shown in FIG. 1B. In the method, the merchant conversion system 40 discovers/finds possible merchants (merchants to provide offers on a mobile voucher system, for example) using automated processes (102) such as web scraping, internet, API's, databases, and various and other data sources. As part of the discovery process, the system determines the correct contact person at the merchant location (102a) (i.e. who is the person with the decision-making authority to authorize an offer) and finds their correct contact information is (e.g. email, fax, phone, other). Once one or more merchants are discovered/found by the system, the information about each merchant is organized, categorized, standardized, and cleaned (104) for placement into the central store 30A (106.) In more detail, the raw data from the aforementioned various processes is verified and modified to storage in the store and the merchants are then categorized by type, locality, size, and various online web metrics. An example of the type of merchant data processed and stored by the system is in Appendix A that is incorporated herein by reference. The system now starts an automated process to select a subset of merchants from the Merchant Database to target with an offer to promote a deal on a platform, such as the mobile voucher system platform when the method is used with the mobile voucher system (108.) During that process, various machine learning processes are used to analyze merchants in Merchant Database and targets a subset of merchants given various criteria (110.) Potential selection criteria (112) may include but not limited to: geography, population density, population demographics, merchant category/subcategory, merchant density, consumer/professional ratings/rankings, average price points, merchant margins, merchant longevity, merchant size, merchant advertising history, and whether the merchant has offered or is offering deals to the public as well as estimates of the consumer demand for the merchant and/or merchant deals.

This part of the process is divided into two sub processes of: 1) determining a set of correct parameters for the particular merchant based on the merchant information (114); and 2) determining whether to give a bonus or advance to the particular merchant based on the merchant information (116.) An example of this processing is shown in more detail in Appendix B which is incorporated herein by reference.

The merchant conversion system may use various different machine learning techniques to produce the results described elsewhere. For example, the merchant conversion system and method may use Bayesian methods, Classification, Regressions, linear and logistic, Ranking, Principal Component Analysis, Unsupervised Learning, Optimization, Clustering, k-Nearest Neighbors, Social Graphs, Support Vector Machines and various classical statistical methods to perform the machine learning.

During the process of determining a set of correct parameters for the particular merchant based on the merchant information (114), the process determines the correct parameters of the deal that mutually benefits the merchant and the offer vendor. Some of the deal parameters (115) can include, but not limited to, are: deal value, deal cost, deal discount, the number of deals to sell, and the revenue split with the merchant.

During the process of determining whether to give a bonus or advance to the particular merchant based on the merchant information (116), the process selects an advance or a bonus or any combination of a bonus or advance or other incentive. The difference between an advance and a bonus is that an advance payment is an advance against future commissions while a bonus is a straight bonus that may not be deducted against future commissions. In either case, the owner of the merchant conversion system may reserve the right to sell enough of the merchant offers to consumers until the balance of the advance or bonus is earned back by the owner of the system (i.e. incentive break-even amounts). Secondly, the process would determine the amount of the bonus or advance. This is created based on historical data along with the current categorization of the targeted merchant (117).

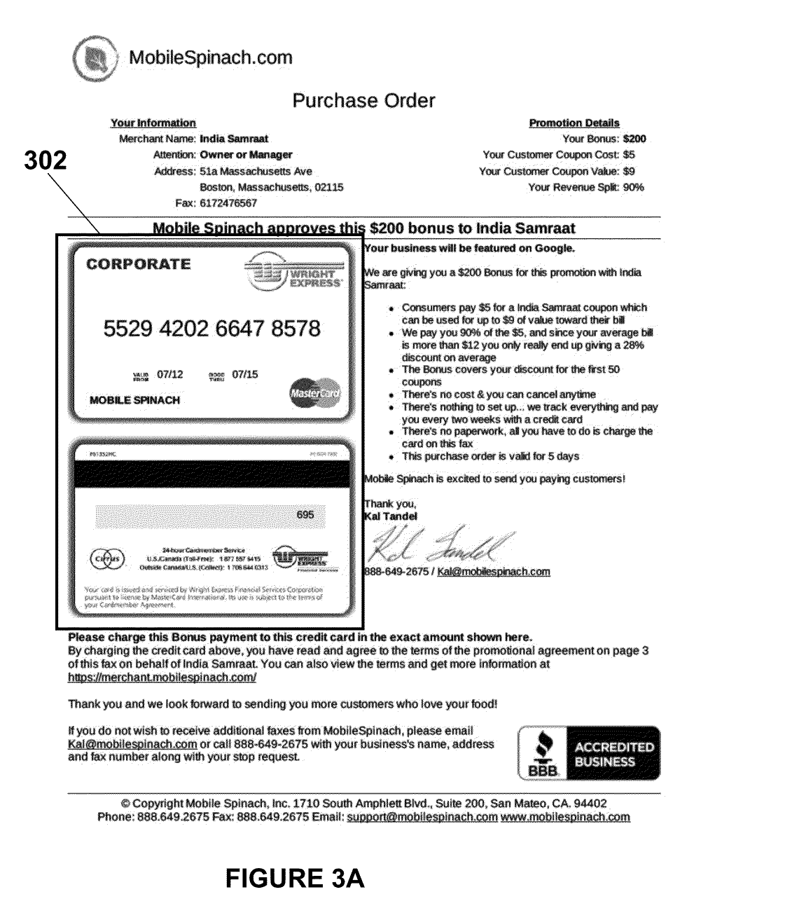

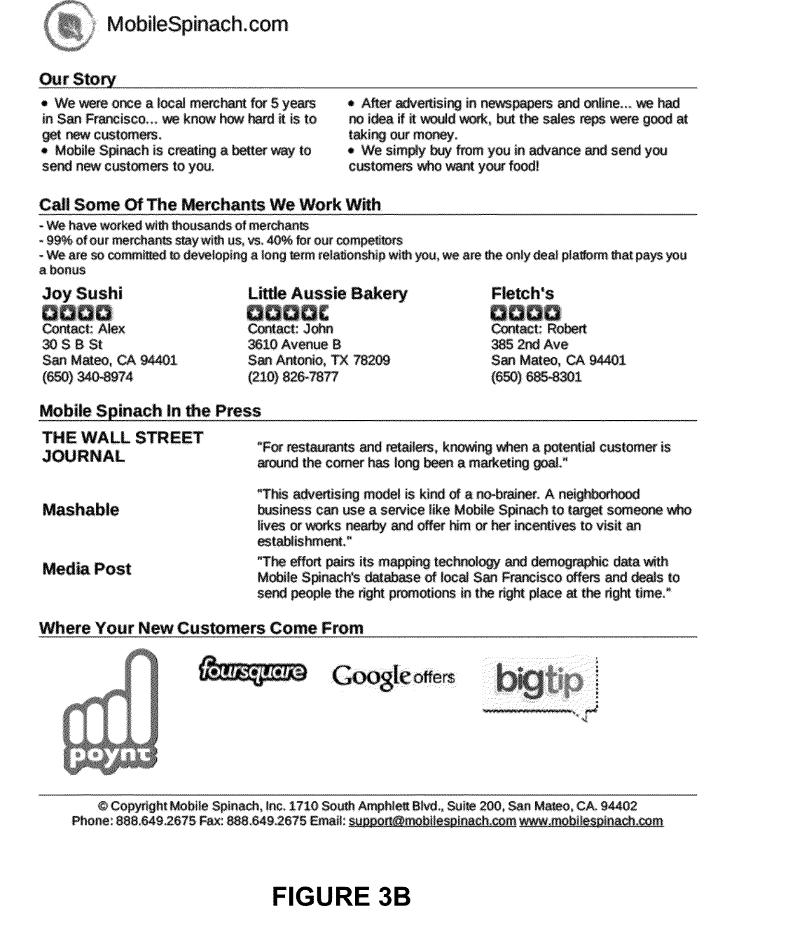

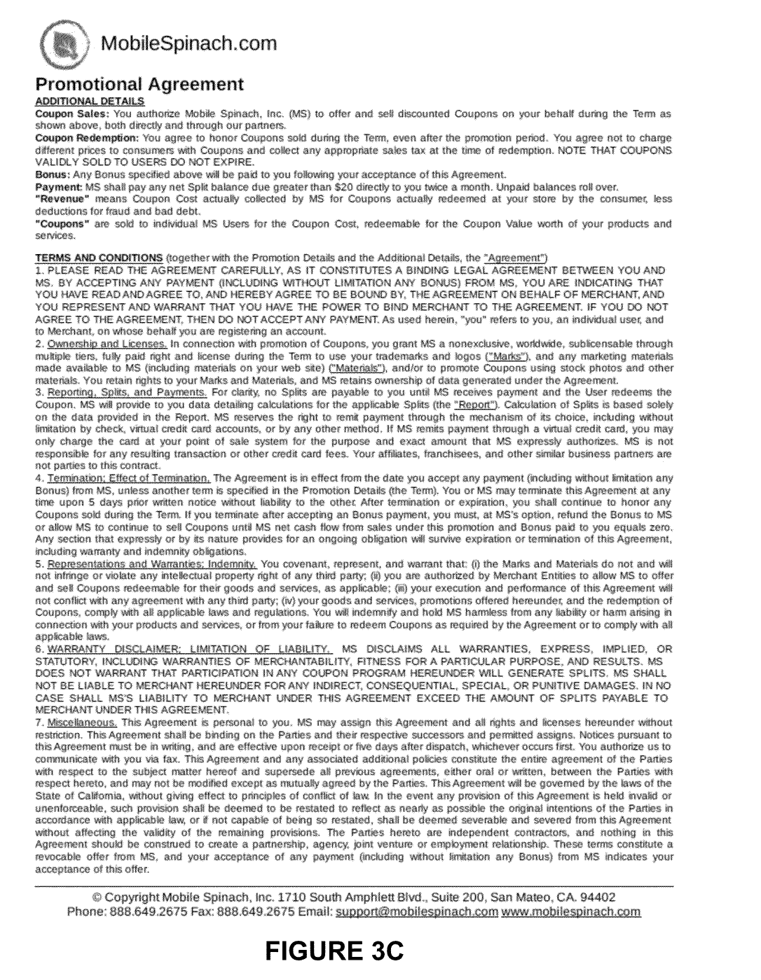

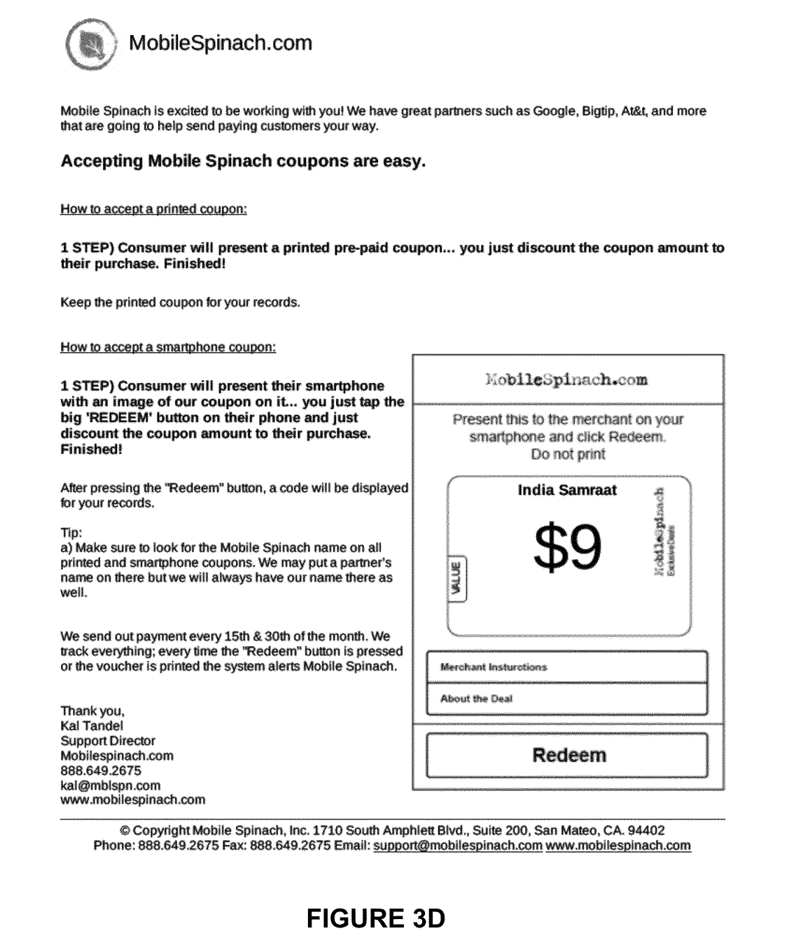

The system may then start the process of contacting (118) the merchants identified by the processes above in the merchant store with the Deal Parameters identified above and Incentive Payments (a bonus or an advance) as determined by the processes described above. Then, the system generates a virtual credit card to pay incentive payment to the particular merchant (examples of which are shown as element 302, 402, 502 and 602 in FIGS. 3A, 4A, 5A and 6A and described in detail below.) In addition to the bonus or advance mentioned above, the incentive may also be a monetary incentive (bonus or advance) and advertisements for the merchant. For example, the system may initially offer a monetary incentive and then offer advertisements to the merchant that may be taken out of the revenue split for the offers.

During this process for the virtual credit card example, the system transmits a request code to a credit card issuing bank via computer network/internet for the virtual credit card number with the specified authorized dollar amount limit as well as expiration date and/or Merchant Category Code (MCC) (122.) It is important to note that these authorized dollar amount limits are set to equal to the previously calculated incentive payment amount for each merchant (124.) Also, only one virtual card number is requested per merchant (126), although more can be generated per merchant. Lastly, the issuing bank transmits the virtual credit card numbers back to the merchant conversion system via the computer network/internet (128.) Instead of the virtual credit card described above, the incentive payments and revenue share payments to the merchants described below can also be transmitted by checks, virtual checks, PayPal (or similar platforms), ACH, bank wire transfers, or any other financial/monetary payment mechanisms or combinations thereof.

In one embodiment, the system generates a unique virtual credit card for each merchant who is being targeted. Once the virtual credit card has been generated for the particular merchant, the system, as part of the process, combines the sales pitch, deal, contract, and virtual credit card information into faxable/e-mailable package (130) for delivery to the targeted merchants. Auto phone dialers may also be used to verbally transmit this information to the targeted merchants. The system may then transmit the virtual credit card, deal and contract information to merchant via fax and/or e-mail (132) in one embodiment. The incentive (that may be a physical credit card as well) may also be transmitted by physical mail, a courier (such as Federal Express) and the like. In this stage of the merchant acquisition process, it is important to note that transmissions are monitored for success or failure (134) and the results are reported back into the system. If the transmission fails numerous times, then the automated program will try to re-obtain the correct fax number or e-mail address (136, 138) and update the associated merchant records and remove the non-working contact information from the merchant information database (140.) Then that merchant may be placed in the queue for re-contacting at a later time. Each unsuccessful contact iteration modifies the machine learning algorithm and stores information within database (142.) In this way, the processes continue to learn by iterating on the new data from the actual results of the campaigns (144.)

If the communication of the package to the particular merchant is successful, the system monitors a virtual credit card queue for the virtual credit card authorization and/or settlement submitted by the merchant (146) so that the automated process will monitor the credit card networks (such as MasterCard's credit card terminal network for example, or any other credit card network) for credit card authorizations of the virtual credit cards by merchants (148.) Other payment mechanism queues including, but not limited to, checks, e-checks, Paypal, ACH, bankwire, may also be monitored for authorizations and/or settlement by the merchants. This point-of-sales network can include, but not limited to, dedicated in-store point-of-sales terminals, internet/online point-of-sales entry, dial in-phone validation, mobile apps, etc. The incentive payment offered and transacted via the virtual credit card enables Mobile Spinach to sign up Merchants without needed traditional paper contracts, and automates the entire process including the offer authorization and related contract signing process. Any authorization of any portion of the incentive payment is considered a successful merchant offer acquisition and authorizations by the merchant are reported back into the machine learning algorithm. If no authorization takes place then it is considered a failed merchant acquisition (150-154) and is reported back into the machine learning process for either re-targeting or removal. Once the merchant receives the fax and charges the virtual credit card, the merchant has digitally e-signed the contract and has agreed to the terms of the deal (no physical signature is needed, as the authorization of the credit card is legally binding for e-signature purposes because they are taking funds from the system . . . although the merchant may physically sign the contract if they are so inclined) (156.) The counterparty verification required to digitally e-sign via charging the credit card is possible because the credit card networks (such as MasterCard for example, but not limited to) can track every credit card authorization to a merchant's specific and uniquely identified point-of-sale credit card terminal and/or account and merchant business name and address. Specifically, every point-of-sale credit card terminal or account has a unique identifying code so that no two are alike. The credit card networks (such as MasterCard for example, but not limited to) are able to pass back to the system this unique point-of-sale terminal code and the merchant's name and address, time, date, and amount of authorization and final settlement, thereby verifying the legal merchant entity for purposes of e-signing the contract by charging the virtual credit card (158.)

This merchant offer is then queued to be automatically launched onto the mobile voucher system network where consumers may buy these offers (160.) The mobile voucher network may include a system website as well as other third party websites on apps (mobile and desktop). In turn, merchants get paid by the number of redeemed offers received by the system. Redeemed offers are offers actually used/redeemed at the merchant by the consumer. The automated program then calculates total purchases, redemptions, payments, and lastly the aforementioned incentive payment break-even amounts before sending the revenue share payments to the merchants as well as informational reports on purchases, redemptions, and payment details to the merchants. Revenue share payments to merchant can be also paid via virtual credit card (generated in a manner similar to the aforementioned incentive payments) or via PayPal or check (162-168.) For each action in this portion of the process flow, the machine learning algorithms are modified and store the information within the merchant information database. For example, actual consumer demand and redemptions for an offer will impact the machine learning algorithm's future iterations. In this way, the machine learning algorithms continue to learn by iterating on the new data from the actual results of the campaigns and are able to adjust the automated parameters for subsequent merchant offer acquisition campaigns.

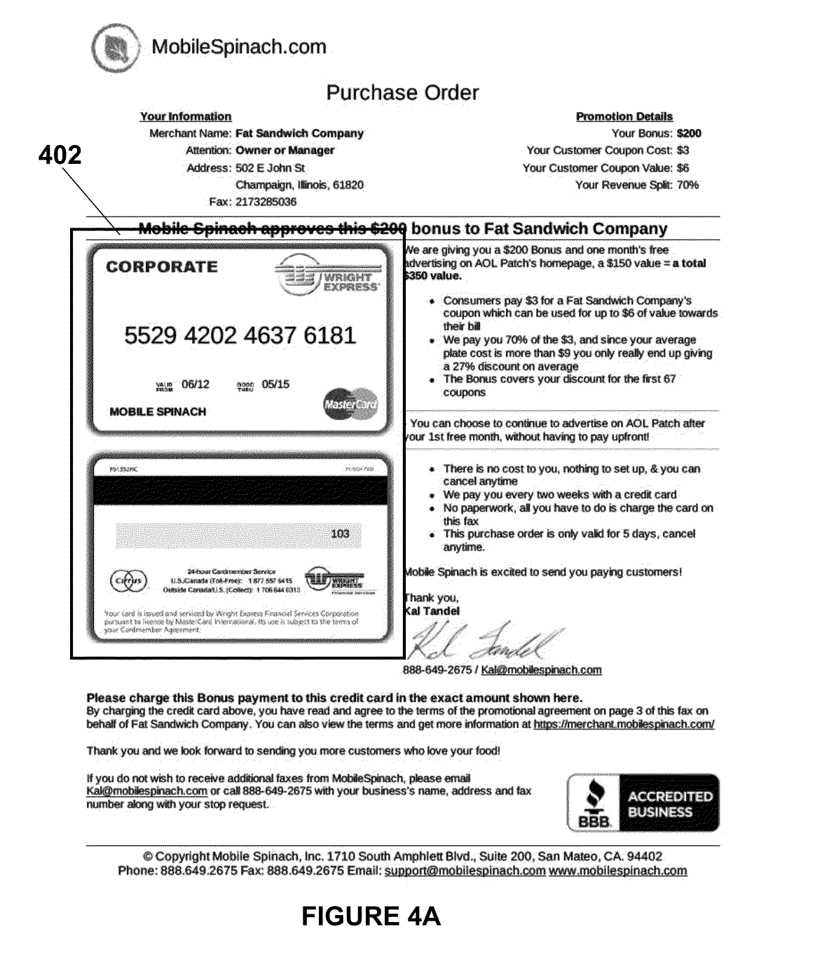

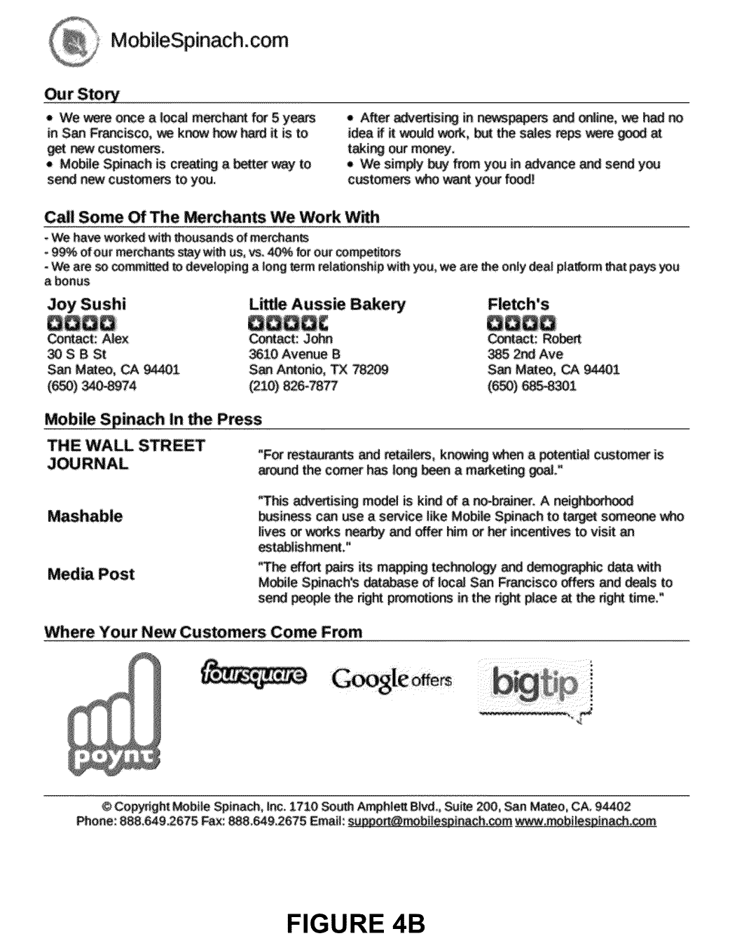

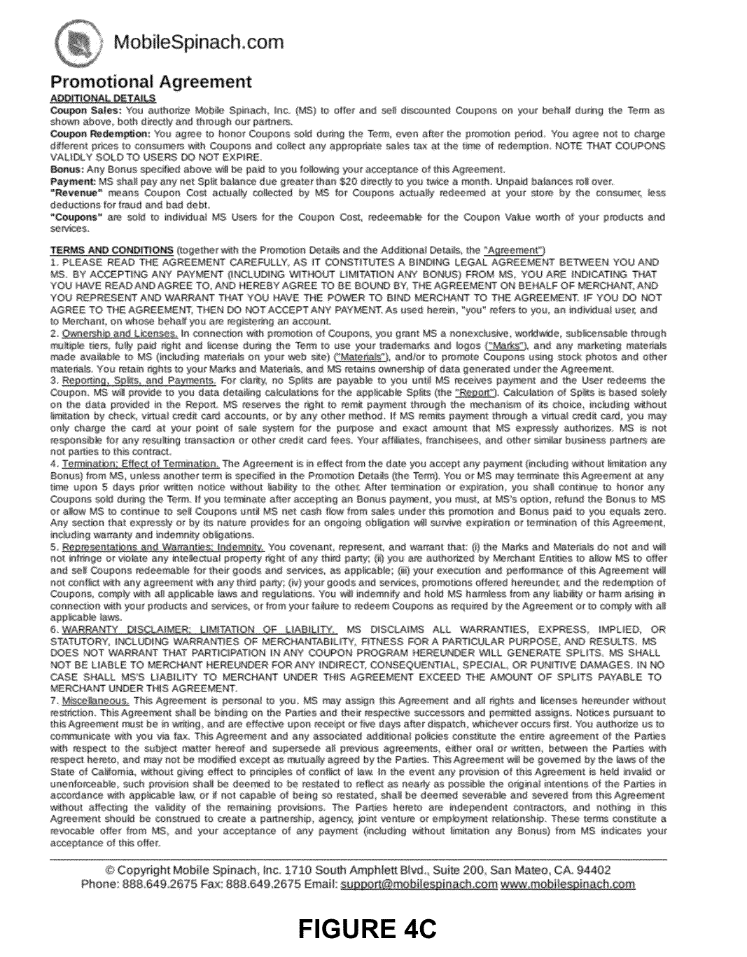

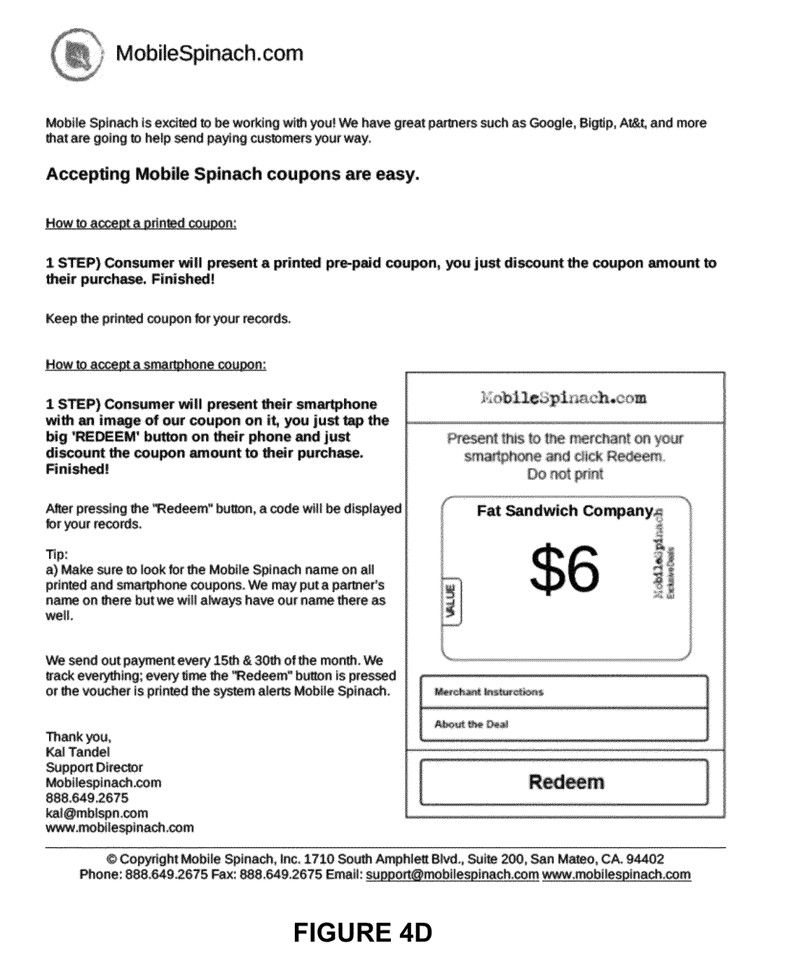

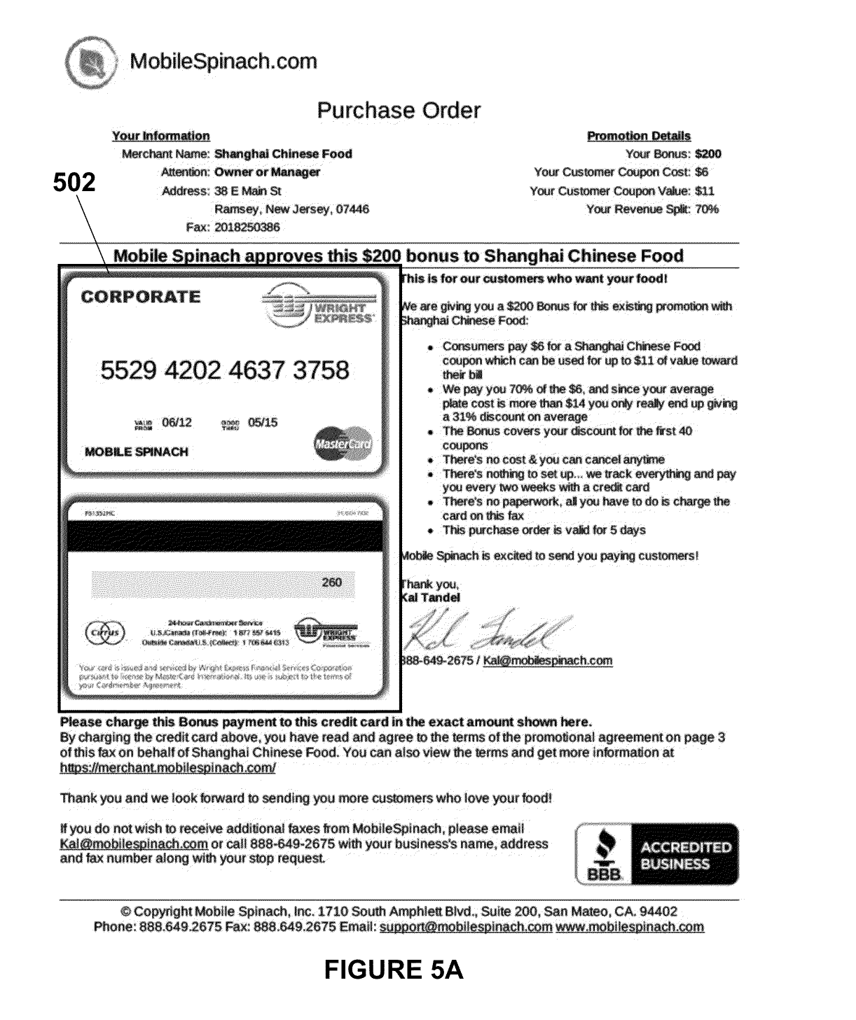

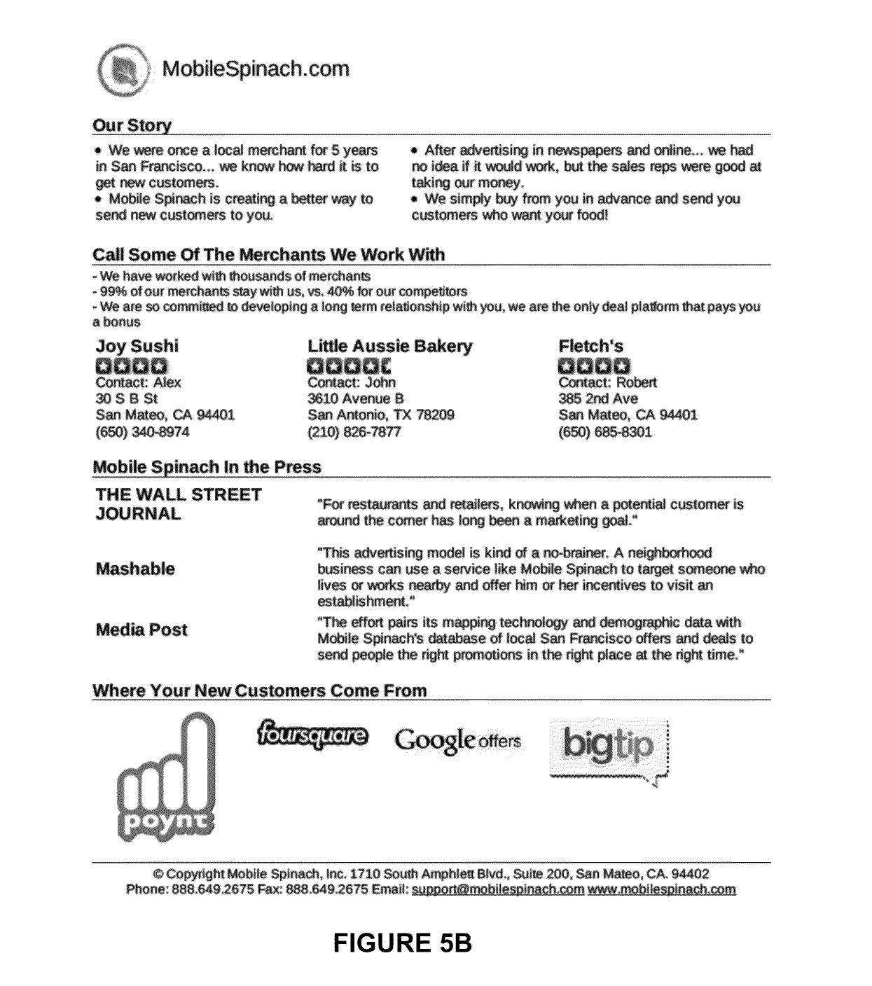

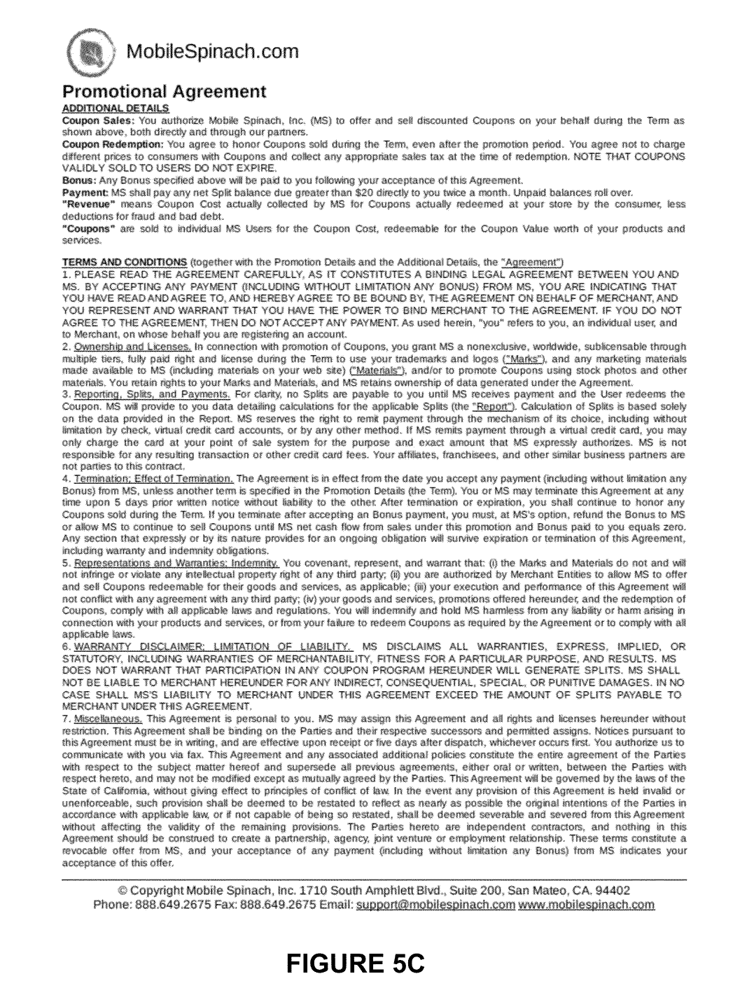

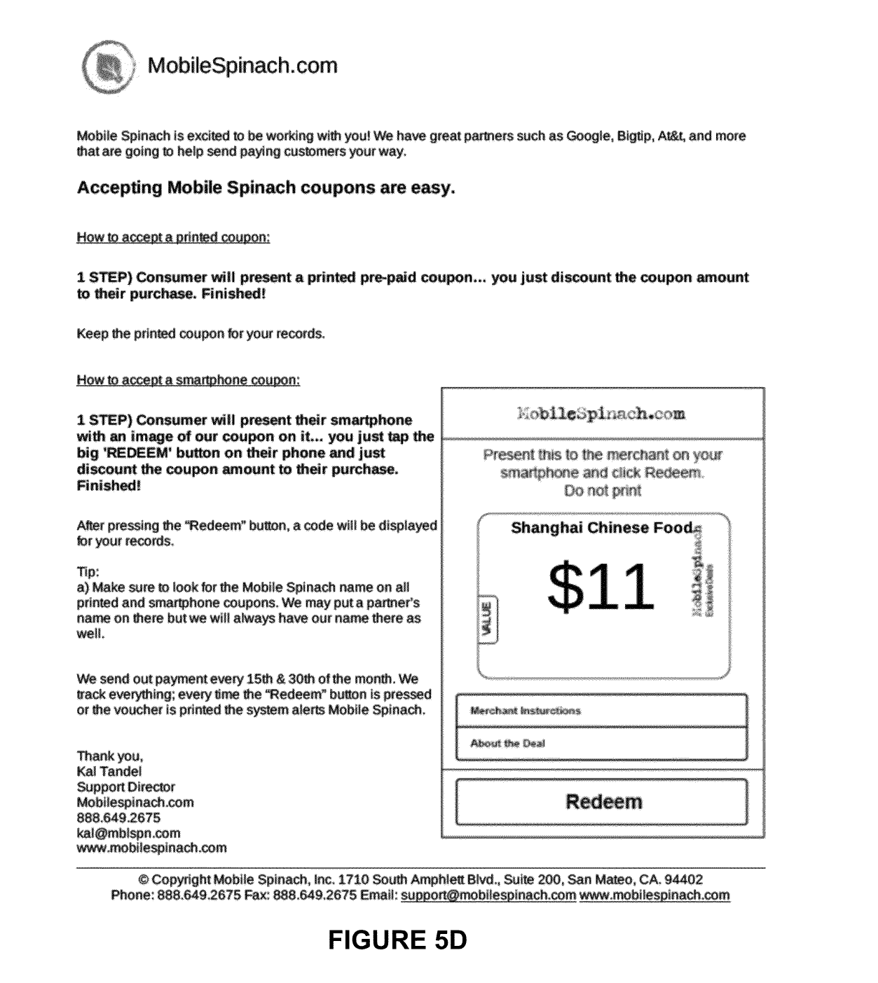

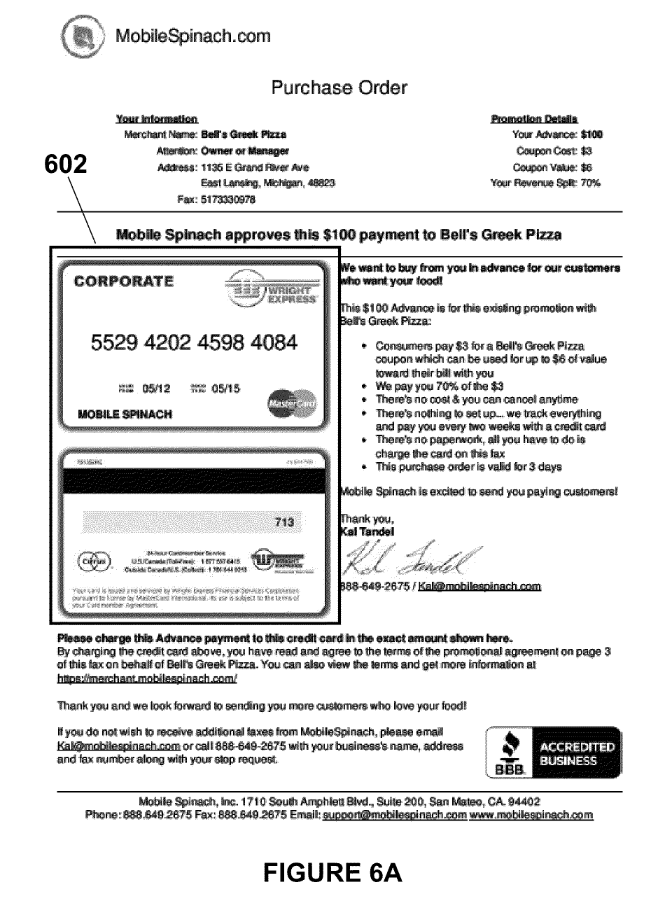

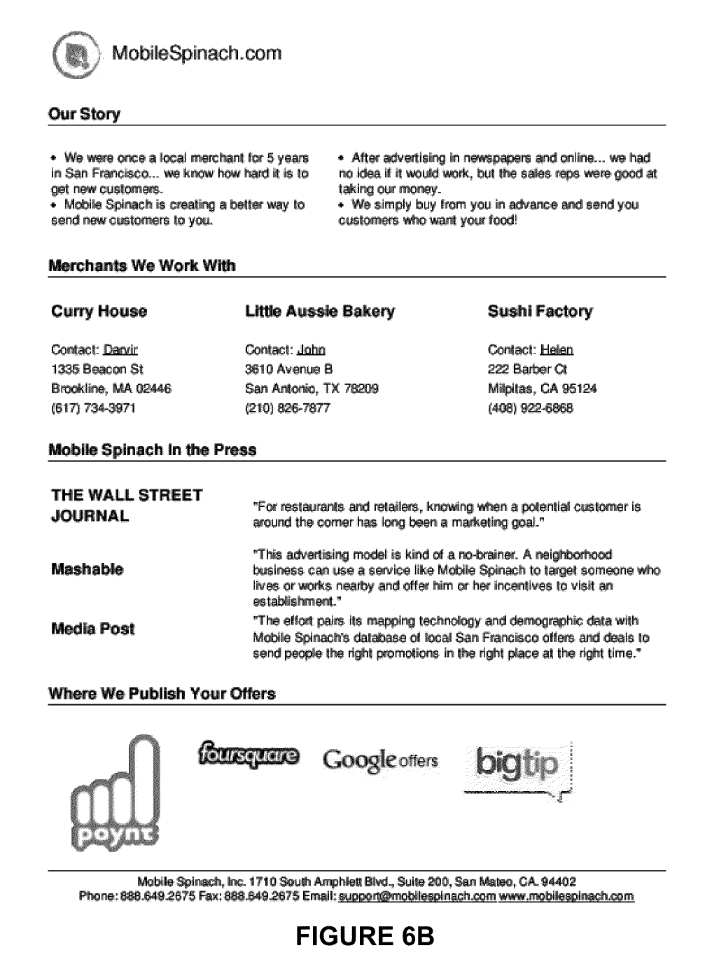

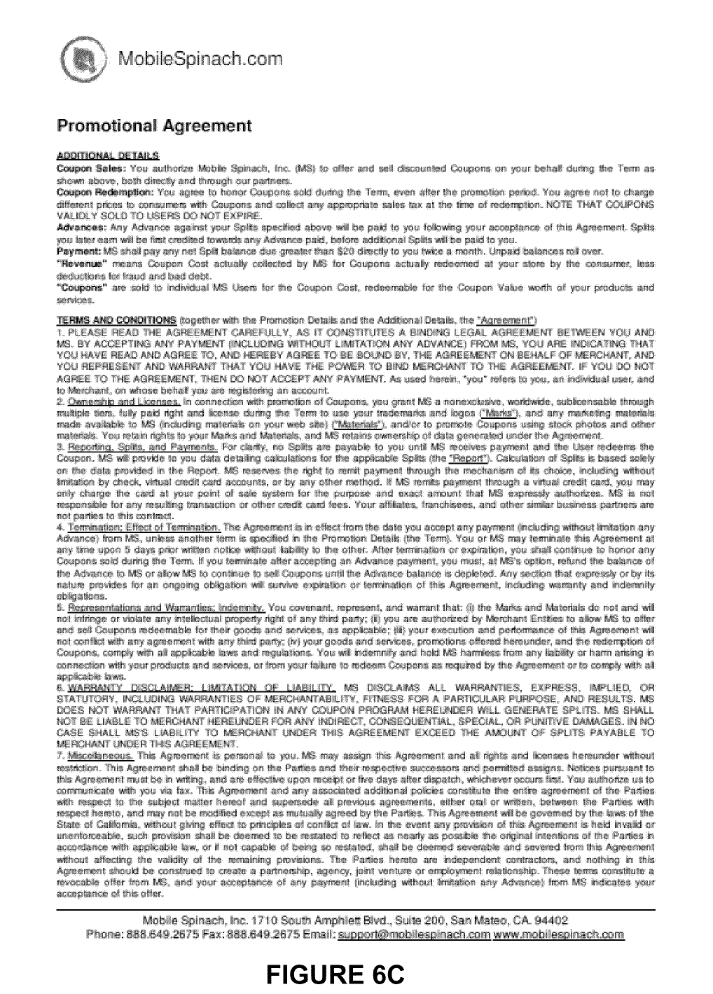

FIGS. 3A-3D illustrates an example of a merchant conversion flyer, FIGS. 4A-4D illustrates another example of a merchant conversion flyer and FIGS. 5A-5D illustrates yet another example of a merchant conversion flyer. These different packages (from different merchants), as described above, are delivered to a particular merchant and customized for each merchant. FIGS. 6A-6C shows an example of a merchant conversion flyer that is using an advance instead of a bonus.

The system described above may have a unit (such as a hardware or software unit in FIG. 1A) that utilizes the merchants who are converted using the system. The unit may be a business to customer system, a business to business system and/or an advertising selling system that utilizes the merchant conversion unit to sign up the particular discovered merchant.

In more detail, the business to business system may be a system for offering local deals and offers. The advertising selling unit may engage the converted merchants to buy media advertising (both print and digital) either as part of a bundle with a local offer or separately. This media advertising can include, but is not limited to, banner advertising, pay-per-click, pay-per-purchase, pay-per-call, directory listing services, print display, radio or television placement and other various media placement.

In more detail, the business to business system may be a lead generation platform for local merchants and other business types, whereby the system discovers the merchants, gathers data on the merchants including, but not limited to, business name, address, contact information, owner/manager name and contact information, business descriptions, business logos/images, consumer reviews, competitors, financial information, goods and services offered (including pricing), etc. This data can then be offered to other 3^{rd} parties for their own purposes.

The business to business system may also be a “platform as a service”, whereby other 3^{rd} parties can use this system to run their own sales and marketing campaigns to engage local merchants, or other industry verticals. Additionally, this system can be used to target other industry verticals besides local merchants, examples include, but are not limited to, industrial business, insurance services (both commercial and retail), business to business companies, medical industry, telesales, and any other industry that would normally by targeted by a human sales force.

While the foregoing has been with reference to a particular embodiment of the invention, it will be appreciated by those skilled in the art that changes in this embodiment may be made without departing from the principles and spirit of the disclosure, the scope of which is defined by the appended claims.

1. An apparatus for merchant conversion, comprising:
a merchant conversion unit that is executed on a processor of a computer to automatically sign up a merchant to an offer wherein the merchant conversion unit discovers a plurality of merchants to whom the offers are made and a set of information about each discovered merchant;
the merchant conversion unit having a machine learning unit that targets a subset of the discovered merchants for offers and determines an incentive to offer to a particular discovered merchant in the subset based on the set of information about the particular discovered merchant; and
the merchant conversion unit having an incentive generator unit that generates an incentive payment and a package for the particular discovered merchant that can convert the particular discovered merchant to a customer of a system when the particular discovered merchant electronically accepts the incentive.

2. The apparatus of claim 1, wherein the merchant conversion unit further comprises a merchant tracking unit that tracks when the particular discovered merchant electronically accepts the incentive.

3. The apparatus of claim 1, wherein the incentive payment is one of a virtual credit card, a check, a credit card, a virtual check, a PayPal payment, an ACH transfer and a bank wire transfer.

4. The apparatus of claim 1, wherein the incentive is one of a bonus to the particular discovered merchant and an advance to the particular discovered merchant.

5. The apparatus of claim 1 further comprising a mobile voucher system that utilizes the merchant conversion unit to sign up the particular discovered merchant for a local merchant offer provided by the mobile voucher system.

6. The apparatus of claim 1 further comprising one of a business to customer system, a business to business system and an advertising selling system that utilizes the merchant conversion unit to sign up the particular discovered merchant.

7. The apparatus of claim 6, wherein the advertising selling system allows the merchant to buy media advertising.

8. The apparatus of claim 7, wherein the media advertising is bundled with the local offer.

9. The apparatus of claim 7, wherein the media advertising is one of a banner advertisement, a pay-per-click, a pay-per-purchase, a pay-per-call, a directory listing service, a print display, a radio advertisement placement, a television advertisement placement and a media advertisement placement.

10. The apparatus of claim 6, wherein the business to business system is a lead generating platform that gathers a set of information about each merchant.

11. The apparatus of claim 10, wherein the set of merchant information is one or more of a business name, an address, a contact, an owner name, a manager name, a business description, a business logo, a consumer review, a competitor, a set of financial information, one of a good and a service offered by the merchant.

12. The apparatus of claim 6, wherein the business to business system is a platform as a service so that a third party operates one of a sales campaign and a marketing campaign using the platform as a service.

13. The apparatus of claim 6, wherein the business to business system targets one or more industry vertical markets.

14. The apparatus of claim 13, wherein the one or more industry vertical markets are one of an industrial business, an insurance service, a business to business company, a medical industry and a telesales industry.

15. The apparatus of claim 1, wherein the incentive generator delivers the payment and package to the particular discovered merchant using one of an electronic mail message, a facsimile, a courier and physical mail.

16. The apparatus of claim 1, wherein the incentive payment is a monetary incentive and one or more advertisements for the particular merchant.

17. The apparatus of claim 16, wherein the monetary inventive is one of a bonus for the particular merchant and an advance for the particular merchant.

18. A method for merchant conversion, the method comprising:
automatically signing up, by a merchant conversion unit that is executed on a processor of a computer, a merchant to an offer by discovering a plurality of merchants to whom the offer is made and a set of information about each discovered merchant;
targeting, using a machine learning unit of the merchant conversion unit, a subset of the discovered merchants for an offer;
determining, by the machine learning unit of the merchant conversion unit, an incentive to offer to a particular discovered merchant in the subset based on the set of information about the particular discovered merchant; and
generating, using an incentive generator unit of the merchant conversion unit, an incentive payment and a package for the particular discovered merchant that can convert the particular discovered merchant to a customer of a system when the particular discovered merchant electronically accepts the incentive.

19. The method of claim 18 further comprising tracking, by a merchant tracking unit of the merchant conversion unit, when the particular discovered merchant electronically accepts the incentive.

20. The method of claim 18, wherein the incentive payment is one of a virtual credit card, a check, a credit card, a virtual check, a PayPal payment, an ACH transfer and a bank wire transfer.

21. The method of claim 18, wherein the incentive is one of a bonus to the particular discovered merchant and an advance to the particular discovered merchant.

22. The method of claim 18 further comprising signing up, using the merchant conversion unit, a merchant for a mobile voucher system for a local merchant offer provided by the mobile voucher system.

23. The method of claim 18 further comprising one of a business to customer system, a business to business system and an advertising selling system that utilizes the merchant conversion unit to sign up the particular discovered merchant.

24. The method of claim 23 further comprising using the advertising selling system to allow the merchant to buy media advertising.

25. The method of claim 24 further comprising bundling, using the advertising selling system, the media advertising with a local offer.

26. The method of claim 24, wherein the media advertising is one of a banner advertisement, a pay-per-click, a pay-per-purchase, a pay-per-call, a directory listing service, a print display, a radio advertisement placement, a television advertisement placement and a media advertisement placement.

27. The method of claim 23, wherein the business to business system is a lead generating platform that gathers a set of information about each merchant.

28. The method of claim 27, wherein the set of merchant information is one or more of a business name, an address, a contact, an owner name, a manager name, a business description, a business logo, a consumer review, a competitor, a set of financial information, one of a good and a service offered by the merchant.

29. The method of claim 23, wherein the business to business system is a platform as a service so that a third party operates one of a sales campaign and a marketing campaign using the platform as a service.

30. The method of claim 23, wherein the business to business system targets one or more industry vertical markets.

31. The method of claim 30, wherein the one or more industry vertical markets are one of an industrial business, an insurance service, a business to business company, a medical industry and a telesales industry.

32. The method of claim 18 further comprising delivering the payment and package to the particular discovered merchant using one of an electronic mail message, a facsimile, a courier and physical mail.

33. The method of claim 18, wherein the incentive payment is a monetary incentive and one or more advertisements for the particular merchant.

34. The method of claim 33, wherein the monetary inventive is one of a bonus for the particular merchant and an advance for the particular merchant.
